(19) United States
(12) Patent Application Publication
(10) Pub. No.: US 2024/0053897 A1
(43) Pub. Date: Feb. 15, 2024

(54) FAST MEMORY CLEAR OF SYSTEM MEMORY

(71) Applicant: INTERNATIONAL BUSINESS MACHINES CORPORATION, Armonk, NY (US)

(72) Inventors: Bulent ABALI, Tenafly, NJ (US); Alper BUYUKTOSUNOGLU, White Plains, NY (US); Craig R WALTERS, Highland, NY (US); Elpida TZORTZATOS, Lagrangeville, NY (US); Bartholomew BLANER, Shelburne, VT (US)

(73) Assignee: INTERNATIONAL BUSINESS MACHINES CORPORATION, Armonk, NY (US)

(21) Appl. No.: 17/818,630

(22) Filed: Aug. 9, 2022

(51) Int. Cl. G06F 3/06; G06F 12/0891

(52) U.S. Cl. CPC G06F 3/0613; G06F 3/0671; G06F 3/0652; G06F 12/0891; G06F 2212/60

(57) ABSTRACT

Various embodiments are provided herein for clearing memory of system in a computing environment. A zero-filled cache line with a single z-bit per entry in the cache directory may be defined. The “z” is a positive integer. A plurality of instruction set architecture (“ISA”) instructions are provided with a single z-bit in a cache line as defined in a cache directory to clear an entire cache line.

### BACKGROUND

The present invention relates in general to computing systems, and more particularly, to various embodiments for clearing of memory of system in a computing environment using a computing processor.

### SUMMARY

According to an embodiment of the present invention, a method for clearing memory of system in a computing environment using a computing processor, is depicted. A zero-filled cache line may be defined with a single z-bit per entry in the cache directory, where “z” is a positive integer. A plurality of instruction set architecture (“ISA”) instructions may set a single z-bit as defined in a cache directory to clear an entire cache line.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting an exemplary functional relationship between various aspects of the present invention.

FIG. 5 is a block diagram depicting operations for clearing of memory of system in a computing environment according to an embodiment of the present invention.

FIG. 6 is a is a flowchart diagram depicting an additional exemplary method for clearing of memory of system in a computing environment according to an embodiment of the present invention.

FIG. 7 is a block diagram depicting operations for clearing of memory of system in a computing environment according to an embodiment of the present invention.

FIG. 8 is a is a flowchart diagram depicting an additional exemplary method for clearing of memory of system in a computing environment according to an embodiment of the present invention.

### DETAILED DESCRIPTION OF THE DRAWINGS

In modern computer systems, memory use is accomplished by a limited set of algorithms that manage the use of memory blocks or sections. Such functions include pre-fetch functions and memory allocation functions that manage memory to select blocks that are available for storage in response to input of data to memory and/or requests of data from various devices (e.g., CPUs, virtual machines, control units, external devices, or users, etc.). Memory management operations include assigning blocks of memory for use by a device, which typically requires clearing the blocks for use to ensure that data from previous usage is not stored therein. Each time the blocks are returned, the blocks are again cleared. In some instances, if blocks were not completely used, a portion of the assigned blocks already exists in a cleared state. In such instances, an effective double clearing is performed that can result in unnecessary use of time and processing resources.

Additionally, computer hardware caches are temporary holding storages for fast access to frequently used memory data. Said differently, to reduce or avoid the time delay (or “latency”) of accessing data stored in the main memory of a computer, modern computer processors include a cache memory (or “cache”) that stores recently accessed data so that it can be quickly accessed again by the processor. Data that is stored in a cache can be quickly accessed by a processor without the need to access the main memory (or “memory”), thereby increasing the performance of the processor and the computer overall. A cache has a shorter access time than the computer system memory (e.g., frequently referred to as dynamic random-access memory, “DRAM”). Caches are typically constructed with Static Random-Access Memory (“SRAM”), which are faster than DRAM. However, cache capacities are smaller than DRAM. The cache/memory access speed and capacity are inversely proportional.

Several different layers of cache may be provided in a computer system. Level 1 (or primary) cache, for example, is used to store data on behalf of system memory (which comprises random access memory, i.e., RAM) for access by a processor. Level 1 (“L1”) cache can be built directly into the processor and can run at the same speed as the processor, providing the fastest possible access time. Level 2 (or secondary) (“L2”) cache is also used to store a portion of system memory and may be included within a chip package but is separate from the processor. Level 2 cache has greater capacity than Level 1 cache but is slower. Some systems may even include Level 3 (“L3”) cache that has even greater capacity than Level 2 cache. However, Level 3 cache is typically slower than Level 2 cache, yet still faster than the primary storage device, and may be located off the chip package.

Data in a cache are stored in “lines,” which are contiguous chunks of data (i.e., being a power-of-2 number of bytes long, aligned on boundaries corresponding to this size). That is, data is typically transferred and accessed in groupings known as cache lines, which may include more than one item of data.

Thus, to clear memory of a system, a significant and large amount of computing resources is necessary, essential, and even repetitive. For example, memory clearing of large data blocks is frequently executed for system initialization or for security reasons. As such, memory clearing can be a long and complex process as it can be executed on each cache line holding the cleared data. This complexity increases with the number of cache lines to be cleared.

Thus, the present invention provides for improving and optimizing memory clearing speeds, while reducing computing processor overheads, to improve and provide increased computing efficiency. Accordingly, various embodiments are provided herein for faster and increased memory clearing speeds of system in a computing environment. In some examples, a zero-filled cache line may be defined with a single z-bit per entry in the cache directory. The “z” may be a positive integer. A plurality of instruction set architecture (“ISA”) instructions are provided with a single z-bit as defined in a cache directory to clear an entire cache line.

In some example, various embodiments provide for exchanging a cache coherency state and the single z-bit for clearing the cache line, and/or exchanging a cache coherency state and the single z-bit for initializing the cache line.

In other examples, various embodiments provide for setting the single z-bit in one or more sequential sets of cache lines in the directory plurality of instruction set architecture (“ISA”) instructions. In other examples, various embodiments provide for setting the single z-bit as a zero bit in when the cache lines are written over by non-zeros. In some example, various embodiments provide for using a clear machine unit to clear a plurality of z-bits in a cache directory.

It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning scheduling agent benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of operations, schedules, PE's, and/or machine learning models/machine learning pipelines, but there may be a variety of factors that may result in alternate suggestion of a combination of operations, schedules, PE's, and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

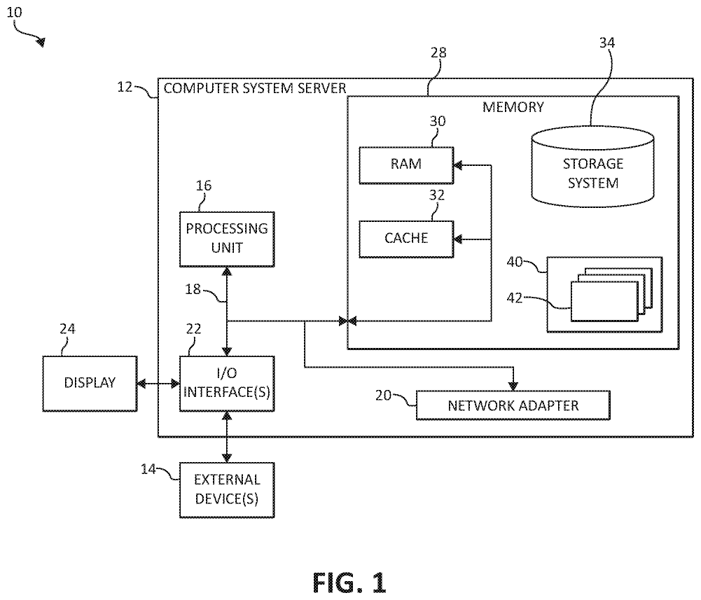

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

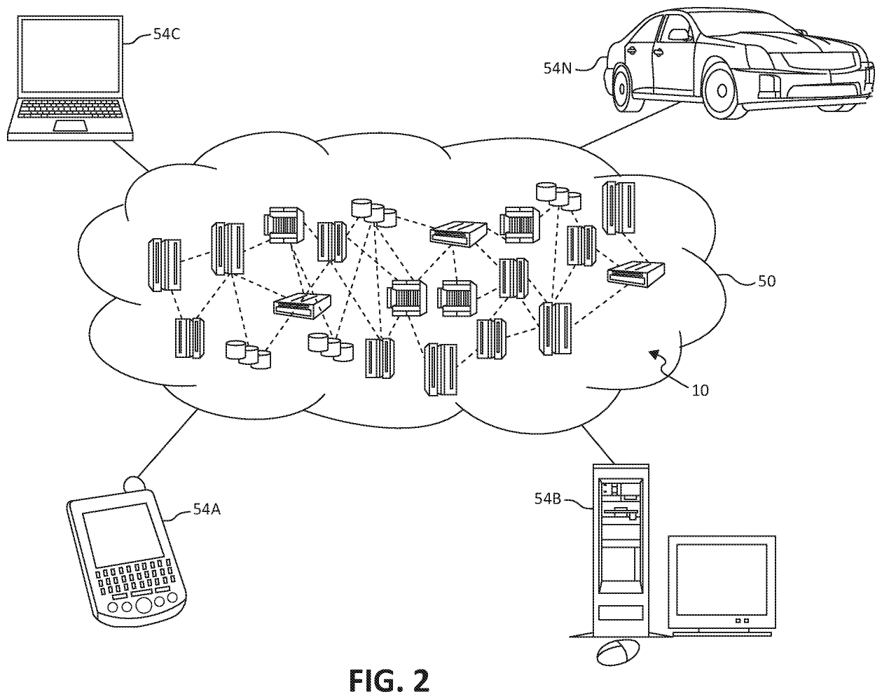

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

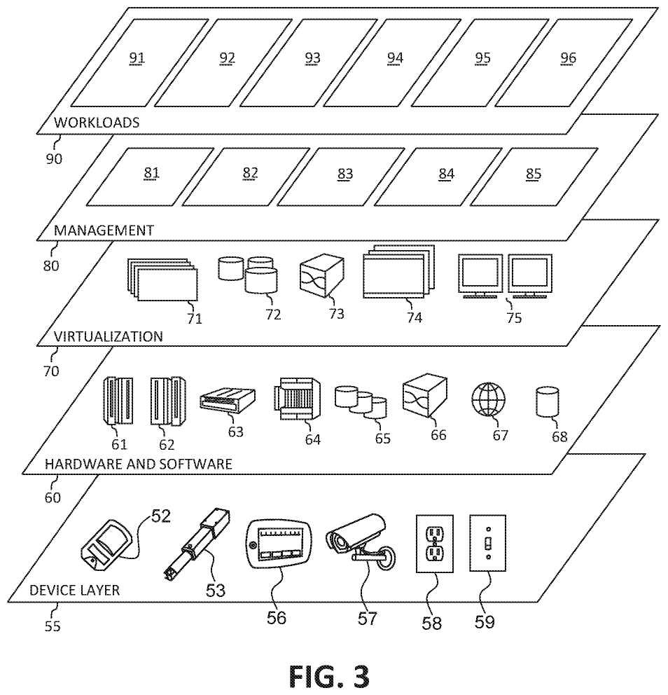

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for clearing of memory of system in a computing environment (e.g., in a neural network architecture). In addition, workloads and functions 96 for clearing of memory of system in a computing environment may include such operations as interleaving and as will be further described, user and device management functions. One of ordinary skill in the art will appreciate that the workloads and functions 96 for clearing of memory of system in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for improving and optimizing memory clearing speeds, while reducing computing processor overheads, to improve and provide increased computing efficiency. Accordingly, various embodiments are provided herein for faster and increased memory clearing speeds of system in a computing environment. In some examples, a zero-filled cache line with a single z-bit per entry in the cache directory may be defined. The “z” may be a positive integer. A plurality of instruction set architecture (“ISA”) instructions are provided with a single z-bit as defined in a cache directory to clear an entire cache line.

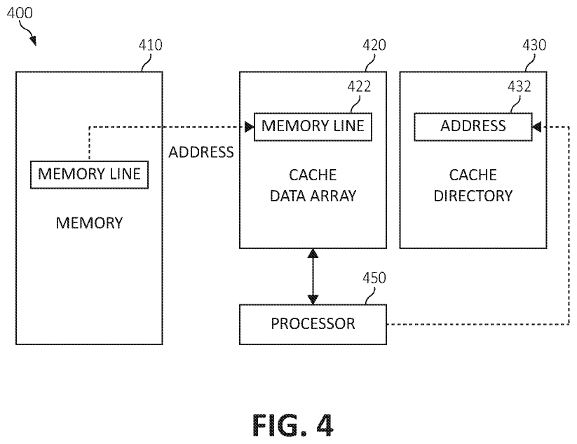

Turning now to FIG. 4, a block diagrams depicting exemplary functional components of a cache system 400 for clearing of memory of system in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

The system 400 comprises of a memory 410, a cache 420 (e.g., cache data array) and a cache directory 430, all of which may be in communication with a processor 450.

Data in the cache 420 are stored in “lines,” such as, for example, memory line 422, which are contiguous chunks of data (i.e., being a power-of-2 number of bytes long, aligned on boundaries corresponding to this size). A cache line 422 of memory data, typically in units of 64 to 256-bytes long, is stored in a data array location and the respective memory address is stored in the directory, as shown in FIG. 4. The processor 450 will supply the memory address to the cache such as, for example, the cache data array 420. If the address is found in the cache directory 430, the processor 450 may access a respective line of data in the cache 420. If the address is not found in the cache directory 430, the processor 450 may access the respective line of data in the memory 410.

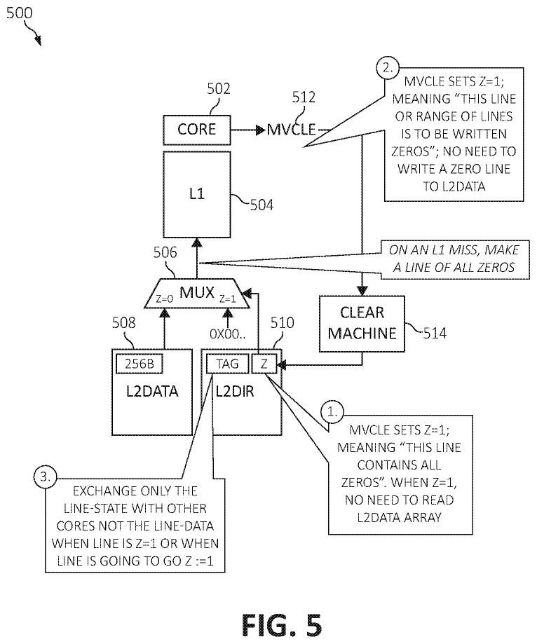

For further explanation, FIG. 5 is a block diagram depicting a cache layer such as, for example, a computing core “core” 502, a first cache layer (e.g., L1) 504, a mux 506, a clear machine 514, cache data 508 (e.g., “L2DATA”), and a cache directory 510 (e.g., “L2DIR”) of a second cache layer (e.g., L2) for clearing of memory of system in a computing environment.

In one aspect, one or more of the components, modules, services, applications, and/or functions described in FIGS. 1-4 may be used in FIG. 5. As shown, various blocks of functionality are depicted with arrows designating the blocks' of system 500 relationships with each other and to show process flow (e.g., steps or operations). Additionally, descriptive information is also seen relating each of the functional blocks' of system 500. As will be seen, many of the functional blocks may also be considered “modules” of functionality, in the same descriptive sense as has been previously described in FIGS. 1-4. Repetitive description of like elements employed in other embodiments described herein is omitted for sake of brevity.

With the foregoing in mind, the module blocks' of systems 500 may also be incorporated into various hardware and software components of a computing system, may also be in a cloud computing environment in accordance with the present invention. Many of the functional blocks of systems 500 may execute as background processes on various components, either in distributed computing components, or elsewhere.

As depicted, the system 500, in step 1), one or more instruction set architecture (“ISA”) instructions (e.g., Move Character Long Extended “MVCLE”, Move Character Long “MVCL”, and/or perform frame management function “PFMF”) may represent (e.g., define) a zero filled cache layer (e.g., “L2”) line with a single Z-bit in a cache directory (e.g., cache layer L2 directory “L2DIR” and the Z-bit is 1 bit per cache line). It should be noted that other data patterns may be indicated by a wider Z field. In some aspects, K-bit Z wide encodes 2 K different patterns (e.g., all ones, blanks, and other common patterns). For example, in some software, memory may be frequently initialized to common patterns such as, for example, the blank ASCII space character 0x20 in hex. A K-bit Z symbol may encode 2^{K} different patterns of interest, where K is a positive integer. Suppose, K is equal to 2, which encodes 2²=4 patterns. Thus, a line full of zeros may be ended with 11, a line full of ones with 01, a line full of blanks with 10, and any other pattern with 00. In this example, when the encoding symbol is other than 00, then the entire line is assumed to be full of the respective pattern, e.g., all blanks in the 10 scenario. As such, clearing/initializing memory may be accelerated with this scheme because instead of writing 256-bytes of blanks to L2DATA, and only 2-bits (10) may be written in L2DIR to indicate that the line contains blanks. This encoding accelerates the process of clearing/initializing the memory because 256-bytes (2048 bits) of data movement is replaced with 2-bits of data movement which is 1024 times smaller.

In one example, the MVCLE instruction may set the single Z-bit equal to one (“1”), which means that this cache line contains all zeros. When the single Z-bit is equal to 1, there is no need or requirement to read the L2data array such as, for example, cache data 508 (e.g., “L2DATA” and the cache directory 510 (e.g., “L2DIR”). This L2DIR encoding of special lines accelerates the process of clearing, initializing, and reading of the cache lines because a 256-bytes of data movement (2048 bits) is replaced with 1-bits of data movement which is 2048 times smaller.

In step 2, one or more ISA instructions may clear a line by setting the single Z-bit as equal to 1 (e.g., “Z=1”). For bulk clear of memory, the one or more ISA instructions may interact with a clear machine 514 to clear multiple single Z-bits in the cache directory (e.g., cache layer L2 directory “L2DIR”). A dedicated clear machine may clear the lines faster than a general purpose processor core and may set Z-bits in the cache directory (e.g., L2DIR). It should be noted that in one example, the clearing memory speed rate may be 5.5 GHz*256=1.4 TB per second. However, the clearing memory speed rate may be less depending on coherency traffic. For example, the MVCLE instruction may set the single Z-bit equal to one (“1”), which means that this cache line or range of lines is to be written as zeros and there is no longer a need to write a zero line to the L2data array such as, for example, cache data 508, 510.

In step 3, when clearing and/or initializing a line, only a cache line's coherency state and the cache line's Z-bit may be cleared. That is, there is no longer a need to transfer the actual 256-byte line from another core and this may because the line may be overwritten. For example, in step 3), only the line-state may be exchanged with other cores and not the line-data when the single Z-bit as equal to 1 (e.g., “Z=1”) or when line is going to go single Z-bit as equal to 1 (e.g., “Z=1”).

In step 4, when the single Z-bit as equal to 1 (e.g., “Z=1”) lines are cast-out to an alternative cache layer such as, for example, L3 or memory, then exchange only the Z state and not the actual line data. When caches exchange the Z-bit as opposed to the entire 256-byte line, the bandwidth utilization across the caches improve substantially because the Z-bit is much smaller than the 256-byte line. Also, the write rate may be accelerated to the alternative cache layer such as, for example, L3 or memory.

Thus, as described herein, the present invention provides for fast clearing of memory by setting one Z-bit per entry in the cache directory (e.g., L2 directory). The single Z-bit as equal to 1 (e.g., “Z=1”) means the respective L2 line data is all zeros. Values in addition to zeros may also be encoded with k-bits (e.g., encode frequently used patterns if the workload requires it, such as, for example, SPACE EBCDIC 0x40 or ASCII 0x20).

A clear-machine 514 sets the single Z-bit as equal to 1 (e.g., “Z=1”) in a sequential set of lines in L2DIR, when commanded by the one or more ISA instructions that are now enabled to be Fast-Clear capable instructions (e.g., MVCL, MVCLE, PFMF) and others. A dedicated clear machine may clear multiple lines faster than a general-purpose processor core.

The embodiments of the present invention for fast clearing of memory can be exploited using the one or more ISA instructions and are transparent to the application software: in the firmware or hardware, and applications can leverage without recompilation. The one or more ISA instructions source register may be examined and when zeros are detected the proposed hardware may execute zeroing. In some examples, one or more of the ISA instructions (e.g., MVCL and other instructions and firmware) may interact with the clear-machine 514. Multiple instructions may be used for clearing memory such as, for example MVCL, MVCLE, PFMF, etc. Different instructions may each utilize the clear-machine per instruction specification, such as amount of memory to clear/initialize, the value to initialize to, e.g., blanks, zeros and so on.

Additionally, the one or more ISA instructions may set the Z-bit as equal to 0 (e.g., “Z=0”) when the respective cache data 508 (e.g., “L2DATA”) line is overwritten with non-zeros (e.g., by the core 502). When the core 502 requests a cache data line to go “Exclusive” for clearing purposes, mechanisms of the illustrated embodiment may exchange only a line-state and the Z-bit and do not request line-data from remote as the line is going to be overwritten, which then saves bus traffic. When a single Z-bit is equal to 1 (e.g., “Z=1”) line is cast-out from an alternative cache layer (e.g., L2), the line-data is not transmitted but rather only the line-state is transmitted to an additional or alternative cache layer such as, for example, cache L3, which also saves ring and bus traffic.

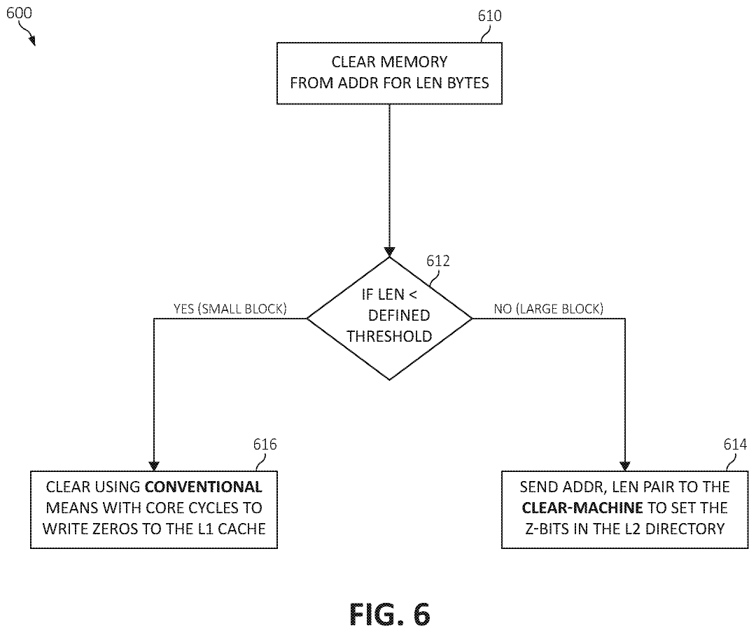

Turning now to FIG. 6, a method 600 for clearing of memory of system in a computing environment using a processor is depicted, in which various aspects of the illustrated embodiments may be implemented. That is, the clearing of memory of system may be for a small block clear optimization (when a cleared line will be accessed soon). The functionality 600 may be implemented as a method (e.g., a computer-implemented method) executed as instructions on a machine, where the instructions are included on at least one computer readable medium or one non-transitory machine-readable storage medium. The functionality 600 may start in block 610.

As a preliminary matter, if only few kilobytes (“KB”) of memory are cleared, then immediate access is highly probable (e.g., short reuse distance) compared to clearing larger blocks, which may be a few hundred KB to megabyte (“MB”) in size (long reuse distance).

In block 610, memory from an address (“ADDR”) for length (“LEN”) bytes may be cleared. In block 612, if the LEN bytes (e.g., small block to be cleared) are less than a defined threshold, the method 600 moves to block 616. In block 616, memory may be cleared using one or more clearing operations (e.g., conventional clearing operations using a method known to one of ordinary skill in the art such as, for example, using the memory store instructions). Alternatively, if the LEN bytes (e.g., large block to be cleared) are greater than a defined threshold, the method 600 moves to block 614.

In block 614 (e.g., operations of FIG. 5), the address and a length pair may be sent to a clear machine (e.g., clear machine 514 of FIG. 4) to set Z-bits in the cache directory (e.g., L2 directory).

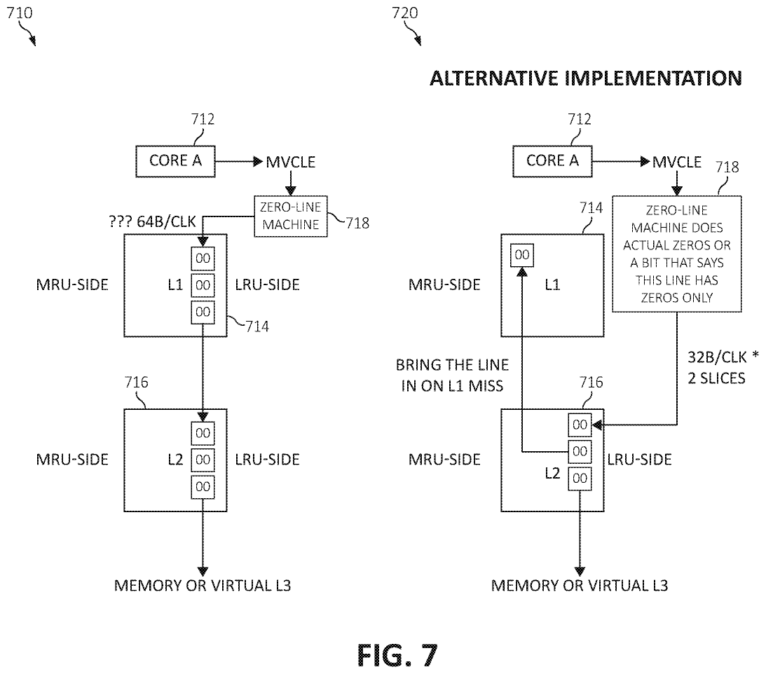

For further explanation, FIG. 7 is a block diagram 700 depicting operations for clearing of memory of system in a computing environment in a computing environment according to an embodiment of the present disclosure. In one aspect, one or more of the components, modules, services, applications, and/or functions described in FIGS. 1-6 may be used in FIG. 7. Repetitive description of like elements employed in other embodiments described herein is omitted for sake of brevity.

As depicted, two operations may be compared such as, for example, operation 710 and operation 720. In both operations 710 and 720, a computing core “core” 702, a first cache layer (e.g., L1) 714 having a most recently used (“MRU”) side and a least recently used (“LRU”) side, and a second cache layer (e.g., L2) 716 having a most recently used (“MRU”) side and a least recently used (“LRU”) side for clearing of memory of system in a computing environment. However, a clear-machine 718 (e.g., clear-machine 514 of FIG. 5) may be used in operations 720.

As depicted, the clear-machine 718 (e.g., a Zero-Line Machine) may clears lines 64B per cycle and sets the line LRU. The clearing memory speed rate may be 5.2 GHz*32 B/clk=166 GB/s, where GHz is gigahertz is, is B is bytes, clk clock, and GB/s is gigabytes per second when the cleared area is cache contained. The LRU is because clearing a contiguous large chunk of memory should not destroy the existing cache L1 and/or cache L2 footprint, but only 1/WAYS fraction of the respective caches. Any size cleared greater than Cache Size/WAYS will evict to cache L3.

Referring to 710, the processor (e.g., core 712) executes the fast-clear capable instruction MVCLE which then commands the Zero-Line state machine 718 to fast-clear multiple sequential lines in the cache. The Zero-Line state machine 718, in turn, commands the L1 cache 714 and L2 cache 716 to make those zero-lines present respectively illustrated by the symbols ‘00’ in L1 cache 714 and L2 cache 716.

Since these multiple lines have sequential addresses, each zero-line maps to a separate cache class called congruence classes in the cache terminology, illustrated by a vertical stack of ‘00’ symbols. While the zero-lines are being made present in the cache, in the 710 embodiments of the invention, they replace the LRU line in each class as expected of the replacement policy.

If the line is not present in the cache, then the LRU line is replaced with the zero-line.

If the line is already present in the cache, then the newly made zero-line is moved to the LRU position (and not the MRU position).

One side effect of clearing multiple sequential lines in memory is when software programmers potentially clear lines either unnecessarily or too early. The embodiments of the present disclosure provides methods for minimizing the performance penalties of those unnecessary and early clears.

In FIG. 7, the zero-line is not moved to the MRU position but moved to the LRU position to mitigate the unnecessary or early clears. Because in some usage scenarios some of those zero-lines will likely to be accessed later or never accessed than those already in the non-LRU positions.

Referring to 720, the processor (e.g., core 712) executes, the Zero-Line state machine 718 does not clear any lines in the L1 cache 714. Instead, the Zero-Line state machine 718 clears lines in the L2 cache 716 only. This embodiment 720 has the advantage of preserving the existing footprint of lines in the L1 cache 714, therefore never replacing any useful lines with unnecessary and late-use lines in L1 cache 714. Only when the processor (e.g., core 712) needs that zero-line that it is brought in to L1 from the L2 cache.

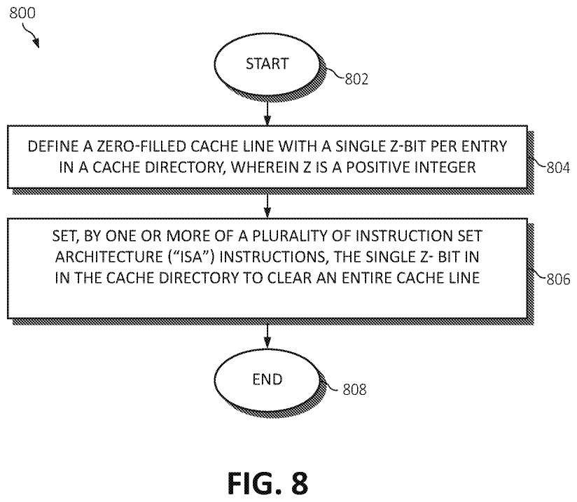

Turning now to FIG. 8, a method 800 for clearing of memory of system in a computing environment using a processor is depicted, in which various aspects of the illustrated embodiments may be implemented. The functionality 800 may be implemented as a method (e.g., a computer-implemented method) executed as instructions on a machine, where the instructions are included on at least one computer readable medium or one non-transitory machine-readable storage medium. The functionality 800 may start in block 802.

A zero-filled cache line may be defined with a single z-bit per entry in the cache directory, wherein z is a positive integer, as in block 804. One or more of a plurality of instruction set architecture (“ISA”) instructions may set a single z-bit in a cache line as defined in a cache directory to clear an entire cache line, as in block 806. The functionality 800 may end, as in block 808.

In one aspect, in conjunction with and/or as part of at least one blocks of FIG. 8, the operations of method 800 may include each of the following. The operations of method 800 may exchange a cache coherency state and the single z-bit for clearing the cache line. The operations of method 800 may exchange a cache coherency state and the single z-bit for initializing the cache line. The operations of method 800 may set the single z-bit in one or more sequential sets of cache lines in the directory plurality of instruction set architecture (“ISA”) instructions. The operations of method 800 may set the single z-bit as a zero bit in when the cache line is written over by non-zeros. The operations of method 800 may use a clear machine unit to clear a plurality of z-bits in a cache directory.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for clearing of memory of a computing system in a computing environment by one or more processors comprising:
setting, by one or more of a plurality of instruction set architecture (“ISA”) instructions, a single bit as defined in a cache directory to clear an entire cache line.

2. The method of claim 1, further including defining a zero-filled cache line according to a value of the single bit per entry in the cache directory.

3. The method of claim 1, further including exchanging a cache coherency state for clearing the cache line with other caches in the computing system according to a value of the single bit sent to the other caches.

4. The method of claim 1, further including exchanging only a cache coherency state among cores of the one or more processors according to a value of the single bit sent to the cores.

5. The method of claim 1, further including setting the single bit in one or more sequential sets of cache lines in the cache directory by commanding a clear-machine to clear the one or more sequential sets of cache lines by the plurality of ISA instructions.

6. The method of claim 1, further including setting the single bit to a value of zero when the cache line is written over by non-zeros.

7. The method of claim 1, further including using a clear machine unit to clear a plurality of bits in the cache directory.

8. A system for clearing of memory of a computing system in a computing environment, comprising:
one or more computers with executable instructions that when executed cause the system to:
set, by one or more of a plurality of instruction set architecture (“ISA”) instructions, a single bit as defined in a cache directory to clear an entire cache line.

9. The system of claim 8, wherein the executable instructions when executed cause the system to define a zero-filled cache line according to a value of the single bit per entry in the cache directory.

10. The system of claim 8, wherein the executable instructions when executed cause the system to exchange a cache coherency state for clearing the cache line with other caches in the computing system according to a value of the single bit sent to the other caches.

11. The system of claim 8, wherein the executable instructions when executed cause the system to exchange only a cache coherency state among cores of the one or more processors according to a value of the single bit sent to the cores.

12. The system of claim 8, wherein the executable instructions when executed cause the system to set the single bit in one or more sequential sets of cache lines in the cache directory by commanding a clear-machine to clear the one or more sequential sets of cache lines by the plurality of ISA instructions.

13. The system of claim 8, wherein the executable instructions when executed cause the system to set the single bit to a value of zero when the cache line is written over by non-zeros.

14. The system of claim 8, wherein the executable instructions when executed cause the system to use a clear machine unit to clear a plurality of bits in the cache directory.

15. A computer program product for clearing of memory of a computing system in a computing environment, the computer program product comprising:
one or more non-transitory computer readable storage media, and program instructions collectively stored on the one or more non-transitory computer readable storage media, the program instructions comprising:
program instructions to set, by one or more of a plurality of instruction set architecture (“ISA”) instructions, a single bit as defined in a cache directory to clear an entire cache line.

16. The computer program product of claim 15, further including program instructions to define a zero-filled cache line according to a value of the single bit per entry in the cache directory.

17. The computer program product of claim 15, further including program instructions to exchange a cache coherency state for clearing the cache line with other caches in the computing system according to a value of the single bit sent to the other caches.

18. The computer program product of claim 15, further including program instructions to set the single bit in one or more sequential sets of cache lines in the cache directory by commanding a clear-machine to clear the one or more sequential sets of cache lines by the plurality of ISA instructions.

19. The computer program product of claim 15, further including program instructions to set the single bit to a value of zero when the cache line is written over by non-zeros.

20. The computer program product of claim 15, further including program instructions to use a clear machine unit to clear a plurality of bits in the cache directory.
